(19) United States
(12) Patent Application Publication
(10) Pub. No.: US 2026/0169614 A1
(43) Pub. Date: Jun. 18, 2026

(54) VIDEO CALL METHOD, APPARATUS, ELECTRONIC DEVICE, AND STORAGE MEDIUM

(71) Applicant: Beijing Zitiao Network Technology Co., Ltd., Beijing (CN)

(72) Inventors: Geyi Cao, Beijing (CN); Xingye Huang, Beijing (CN); Lai Tong, Beijing (CN); Ming Zhang, Beijing (CN); Zhipeng Cheng, Beijing (CN)

(21) Appl. No.: 18/725,096

(22) PCT Filed: Dec. 12, 2022
(86) PCT No.: PCT/CN2022/138417

§ 371 Date: Jun. 27, 2024

(30) Foreign Application Priority Data
Dec. 31, 2021 (CN) 202111670634.4

(51) Int. Cl. G06F 3/0484; G06F 3/0482; H04L 12/18

(52) U.S. Cl. CPC G06F 3/0484; G06F 3/0482; H04L 12/1813

(57) ABSTRACT

The disclosure relates to the field of computer technology, and in particular, to a video call method, apparatus, electronic device and storage medium. The video call method provided according to the embodiments of the present disclosure. In the method, in response to a first video call mode of a client being selected, the first video call mode is started. A video and a virtual background corresponding to the first video call mode are displayed in a local image display box; wherein the client further has a second video call mode, and a virtual background display policy corresponding to the first video call mode is different from a virtual background display policy corresponding to the second video call mode.

### CROSS REFERENCE TO RELATED APPLICATION

This application is the U.S. National Stage of International Application No. PCT/CN2022/138417, filed on Dec. 12, 2022, which is based on and claims priority to Chinese Application No. 202111670634.4 entitled “video call method, apparatus, electronic device and storage medium” filed on Dec. 31, 2021, the disclosures of which are incorporated herein by reference in their entities.

### FIELD

The present disclosure relates to computer field, and specifically to a video call method, device, electronic device and storage medium.

### BACKGROUND

With the development of Internet technology, more and more users are adopting telecommuting, teleconferencing, tele-education and so on. All these online activities involve the use of video call functions. However, remote call functions provided by the related art cannot meet the diversified usage needs and usage scenarios of users.

### SUMMARY

This Summary is provided to introduce concepts in a simplified form that are further described below in the Detailed Description. This Summary is not intended to identify key features or essential features of the technical solution as defined, nor is it intended to be used to limit the scope thereof.

In a first aspect, according to one or more embodiments of the present disclosure, a video call method is provided, comprising:
in response to a first video call mode of a client being selected, starting the first video call mode;
displaying a video and a virtual background corresponding to the first video call mode in a local image display box;
wherein the client further has a second video call mode, and a virtual background display policy corresponding to the first video call mode is different from a virtual background display policy corresponding to the second video call mode.

In a second aspect, according to one or more embodiments of the present disclosure, a video call apparatus is provided, comprising:
a first mode starting unit configured to, in response to a first video call mode of a client being selected, start the first video call mode;
a display unit configured to display a video and a virtual background corresponding to the first video call mode in a local image display box;
wherein the client further has a second video call mode, and a virtual background display policy corresponding to the first video call mode is different from a virtual background display policy corresponding to the second video call mode.

In a third aspect, according to one or more embodiments of the present disclosure, an electronic device is provided, comprising: at least one memory and at least one processor; wherein the memory is used to store program code, and the processor is used to call the program code stored in the memory to cause the electronic device to perform the video call method provided by one or more embodiments of the present disclosure.

In a fourth aspect, according to one or more embodiments of the present disclosure, a non-transitory computer storage medium is provided, which stores program code thereon, the program code, when executed by a computer device, causing the computer device to perform the video call method provided by one or more embodiments of the present disclosure.

According to one or more embodiments of the present disclosure, in response to a first video call mode of a client being selected, the first video call mode is started, and a video and a virtual background corresponding to the first video call mode are displayed in a local image display box; wherein the client further has a second video call mode, a virtual background display policy corresponding to the first video call mode is different from a virtual background display policy corresponding to the second video call mode. In this way, a virtual background that matches a current video call mode may be displayed during a video call, thereby improving the adaptability of the virtual background to the current video call mode and meeting the user's diverse and personalized video call needs.

### BRIEF DESCRIPTION OF THE DRAWINGS

The above and other features, advantages and aspects of the present disclosure will become more apparent in combination with the accompanying drawings and with reference to the following detailed description. The same or similar reference symbols refer to the same or similar elements throughout the figures. It should be understood that the figures are merely schematic, and components and elements are not necessarily drawn scale.

FIG. 1 shows a flowchart of a video call method provided by an embodiment of the present disclosure;

FIG. 2 shows a schematic diagram of a call preparation interface provided by an embodiment of the present disclosure;

FIG. 3 shows a schematic diagram of a call preparation interface and a first set of candidate virtual backgrounds provided by another embodiment of the present disclosure;

FIG. 4 shows a schematic diagram of a first set of candidate virtual backgrounds provided by still another embodiment of the present disclosure;

FIG. 5 shows a structural schematic diagram of a video call apparatus provided by an embodiment of the present disclosure; and

FIG. 6 shows a structural schematic diagram of an electronic device provided by an embodiment of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in the implementations of the present disclosure may be performed in a different order and/or in parallel. In addition, the implementations may comprise an additional step and/or omit a step which is shown. The scope of the present disclosure is not limited in this regard.

The term “comprise” and its variants used herein are to be read as open terms that mean “include, but is not limited to.” The term “based on” is to be read as “based at least in part on.” The term “one embodiment” is to be read as “at least one embodiment.” The term “another embodiment” is to be read as “at least one other embodiment.” The term “some embodiments” is to be read as “at least some embodiments.” The term “in response to” and related terms mean that one signal or event is affected by another signal or event to some extent, but not necessarily completely or directly. If event x occurs “in response to” event y, then x may respond to y, directly or indirectly. For example, the occurrence of y may eventually lead to the occurrence of x, but there may be other intermediate events and/or conditions. In other cases, y may not necessarily cause x to occur, and x may occur even if y has not yet occurred. Furthermore, the term “in response to” may further mean that “at least partly in response to”.

The term “determine” broadly covers a wide variety of actions that may include obtaining, calculating, computing, processing, deriving, investigating, looking up (e.g., in a table, database, or other data structures), ascertaining, and similar actions and may further include receiving (e.g., receiving information), accessing (e.g., accessing data in memory) and similar actions, as well as parsing, choosing, selecting, creating, and similar actions, etc. Relevant definitions of other terms will be given in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.” For the purposes of the present disclosure, the phrase “A and/or B” means (A), (B) or (A and B).

Names of messages or information interacted between a plurality of apparatuses in the implementations of the present disclosure are merely for the illustration purpose, rather than limiting the scope of these messages or information.

Referring to FIG. 1, this figure shows a flowchart of a video call method 100 provided by an embodiment of the present disclosure. The method 100 comprises:
Step S120: in response to a first video call mode of a client being selected, starting the first video call mode;
Step S140: displaying a virtual background and a video (for example, a video including at least one local video image) corresponding to the first video call mode in a local image display box; wherein the client further has a second video call mode, and a virtual background display policy corresponding to the first video call mode is different from a virtual background display policy corresponding to the second video call mode.

In some embodiments, the client may display entrances or marks corresponding to the first video call mode and the second video call mode respectively, and the user may start the first video call mode or the second video call mode by entering different entrances or triggering different marks.

In one implementation, the first video call mode has an exclusive virtual background. In the first video call mode, the local image initially displays the exclusive virtual background by default.

In another embodiment, the first video call mode and the second video call mode correspond to different candidate virtual background sets for the user to select for the first video call mode or the second video call mode. Further, the virtual background set corresponding to the first video call mode includes the exclusive virtual background of the first video call mode, and the virtual background set corresponding to the second video call mode does not include the exclusive virtual background.

According to one or more embodiments of the present disclosure, in response to the first video call mode of the client being selected, the first video call mode is started, and the virtual background and video corresponding to the first video call mode are displayed in the local image display box; wherein the client further has a second video call mode, and the virtual background display policy corresponding to the first video call mode is different from the virtual background display policy corresponding to the second video call mode. In this way, a virtual background that matches the current video call mode may be displayed during a video call, thereby improving the adaptability of the virtual background to the current video call mode and meeting the user's diverse and personalized video call needs.

It should be noted that the local image display box specifically includes, but is not limited to, a local image display box displayed during the video call stage, or the video initiation stage, video connection stage, video debugging stage, or video preparation stage before the video call. The present disclosure is not intended to limit in this regard.

In some embodiments, the virtual background corresponding to the first video call mode is a virtual background set for the first video call mode by a user with predetermined permissions.

As an example, the user with predetermined permissions may be an administrator user, who may specify in advance the virtual background of the first video call mode.

In some embodiments, step S140 comprises:
Step A1: if the first video call mode is set with a first virtual background by the user with predetermined permission, displaying the first virtual background and the video in the local image display box when the first video call mode is started for the first time after the first virtual background is set.

Illustration is presented below by taking a video interview scenario as an example. The administrator may be given the permission to set the virtual background corresponding to the first video mode. Based on this permission, the administrator may set or modify the virtual background displayed in the local image display box when the interviewer is conducting a video interview, by uploading a picture locally, inputting the URL of a picture, selecting a picture from pictures displayed by the system, etc. If the interviewer logs into the client for the first time and starts the first video call mode after the administrator has set or modified the virtual background, the virtual background set or modified by the administrator will be displayed by default in the local image display box. The above settings of the administrator do not affect the configuration of the virtual background in the second video call mode.

In some embodiments, the method 100 further comprises:
Step S160: in response to a predetermined operation, displaying a first set candidate virtual backgrounds corresponding to the first video call mode for the user to select a virtual background for the first video call mode; wherein the first set of candidate virtual backgrounds comprises virtual backgrounds corresponding to the first video call mode and virtual backgrounds corresponding to the second video call mode.

In some embodiments, the first set of candidate virtual backgrounds may be displayed in response to a predetermined operation after starting the first video call mode and before formally conducting a video call, so that the user may promptly select virtual a background for this video call before formally joining the video call.

In some embodiments, a local image preview box may be displayed after starting the first video call mode and before formally conducting the video call. The local image preview box corresponds to a predetermined background setting mark, which is used to display the first set of candidate virtual backgrounds after triggered. In this way, when the user comes to realize that he/she needs to select a virtual background for a video call after he/she sees the image displayed in the local image preview box before formally entering the call, he/she can promptly trigger the background settings mark corresponding to the local image preview box to display the first set of candidate virtual backgrounds, so that the user can promptly select a virtual background for the video call before formally joining the video call.

In some embodiments, the first video call mode and the second video call mode have different startup methods. The first video call mode may be started based on the triggering of a video control in resume document information of a call recipient; or the first video call mode may be started based on the triggering of a first predetermined control in a predetermined schedule panel. The second video call mode may be started based on the triggering of a second predetermined control in the predetermined schedule panel; alternatively, the second video call mode may be started based on the triggering of a video call control in a chat session.

In some embodiments, if the user has joined only one tenant, when the current user starts the first video call mode, current tenant information to which the current user belongs is determined, a virtual background corresponding to the tenant information is called, and the virtual background and a video are displayed in the local image display box.

In some embodiments, if the current user has joined a plurality of tenants, when the current user starts the first video call mode, current tenant information to which the current user belongs is determined, a virtual background corresponding to the tenant information is called, and the virtual background and a video are displayed in the local image display box.

In some embodiments, if the current user has joined a plurality of tenants, when the current user starts the first video call mode, all tenant information is displayed, and in response to the current user's selection of the tenant information, a virtual background corresponding to the selected tenant information is called, and the virtual background and a video are displayed in the local image display box.

Herein, the tenant can be considered as a user group including a plurality of users.

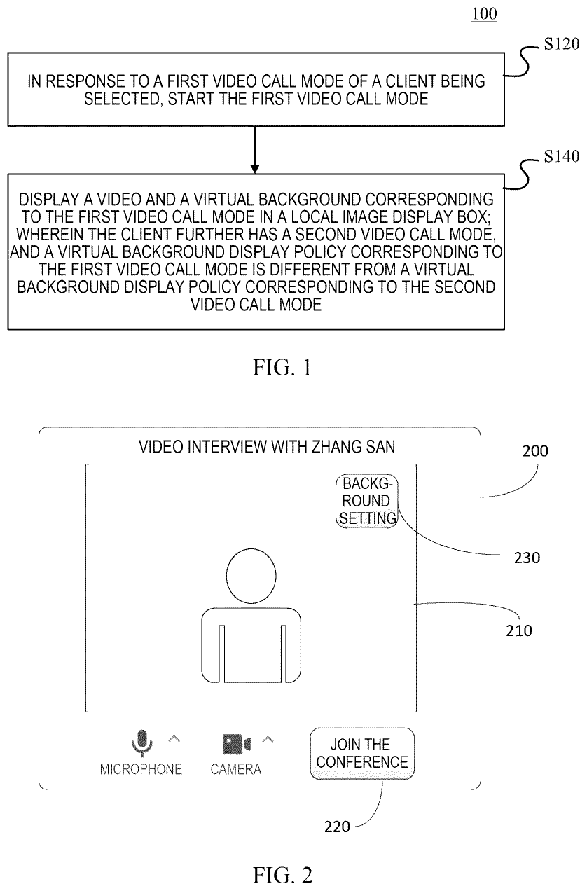

As an example, referring to FIG. 2, after the current user starts the first video call mode and before formally joins the conference or call, a call preparation interface 200 may be displayed, where a local image preview box 210 and a call joining mark 220 and a background setting mark 230 are displayed.

Herein, the local image preview box 210 may display real-time images captured by a camera, or only display user images among real-time images and a default initial virtual background.

The current user may trigger the call joining mark 220 to formally join the conference. Before formally joining the conference, the current user may further view and debug his or her video image, set the microphone, camera and the like through the call preparation interface 200.

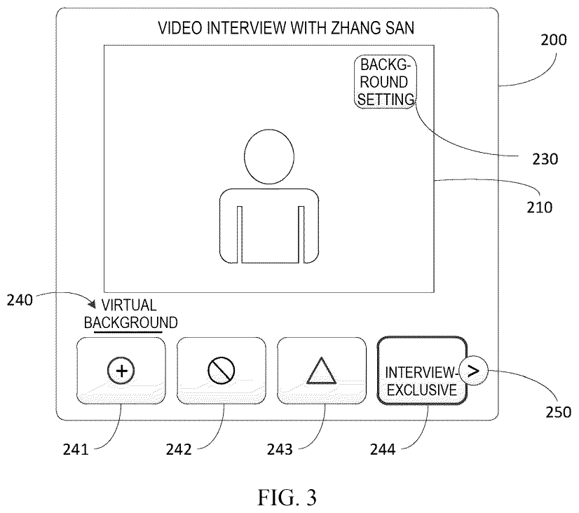

The user may further trigger the background setting mark 230 to select a virtual background for the video call. Referring to FIG. 3, after the background setting mark 230 is triggered, the first set 240 of candidate virtual backgrounds may be displayed, which is located below the local image preview box 210 in the call preparation interface 200. The first set 240 of candidate virtual backgrounds currently displays a background adding mark 241, a background delete mark 242, a background filter mark 243, and a virtual background 244 corresponding to the first video call mode. In addition, a browsing mark 250 corresponding to the first set 240 of candidate virtual backgrounds is further displayed. The browsing mark 250, after being triggered, may display other virtual backgrounds that are not currently displayed in the first set of candidate virtual backgrounds, e.g., virtual backgrounds corresponding to the second video call mode.

The background adding mark 241 is used to add the user's customized virtual background to the first set of candidate virtual backgrounds after being triggered. For example, after the user triggers the background adding mark 241, the user may upload a picture locally as the virtual background of the current call. The user may further trigger the background delete mark 242 to cause the local image preview box not to display the virtual background; the user may further trigger the background filter mark 243 to cause the actual background displayed in the local image preview box to be subjected to a predetermined processing, e.g., fuzzy processing, blurring processing, etc.

Referring to FIG. 3, the user may select a virtual background 244 as the background of the current call, and the local image preview box 210 may display the virtual background selected by the user in real time, thereby presenting the actual display effect of the virtual background in real time. After the user selects from the first set of candidate virtual backgrounds, the user may return to the video call preparation interface 200 shown in FIG. 2 and trigger the call joining mark 220 to formally conduct a video interview with “Zhang San”.

In some embodiments, in the first set of candidate virtual backgrounds, the virtual background corresponding to the first video call mode has a higher display priority than the virtual background corresponding to the second video call mode.

In some embodiments, in the first set of candidate virtual backgrounds, the virtual background corresponding to the first video call mode is marked by a predetermined mark corresponding to the first video call mode; and/or, in the first set of candidate virtual backgrounds, the virtual background corresponding to the first video call mode is displayed before the virtual background corresponding to the second video call mode.

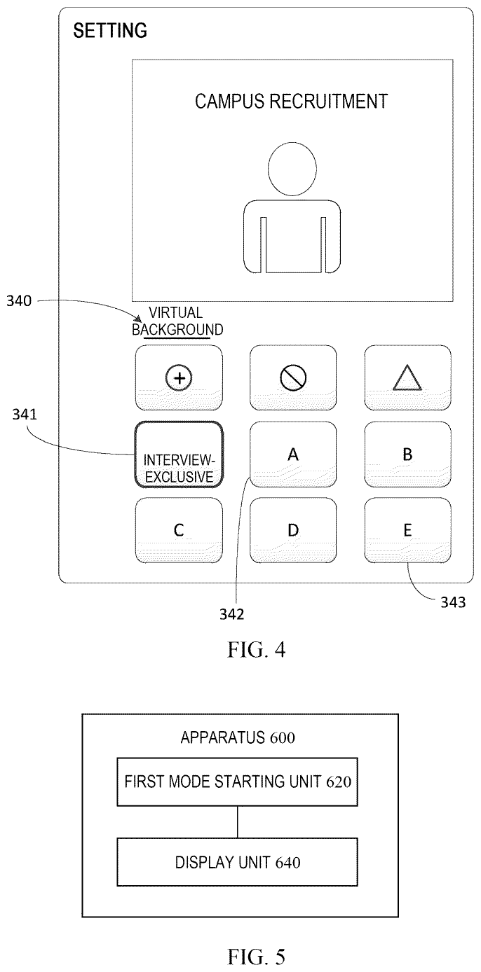

As an example, referring to FIG. 4, this figure shows a schematic diagram of a first set of candidate virtual backgrounds provided by another embodiment. A first set 340 of candidate virtual backgrounds displays a virtual background 341 corresponding to the first video call mode, a virtual background 342 corresponding to the second video call mode, and a customized virtual background 343 uploaded by the user himself. The virtual background 341 is displayed before the virtual background 342, and the virtual background 341 is marked with a predetermined text mark “Interview Exclusive”, thereby reminding the user to first select the virtual background 341 in the first video call mode.

In some embodiments, the second video call mode corresponds to a second set of candidate virtual backgrounds, which does not display the virtual background corresponding to the first video call mode.

In some embodiments, the method 100 further comprises:
Step S170: in response to the user adding a customized virtual background to the first set of candidate backgrounds, adding the customized virtual background to the second set of candidate virtual backgrounds.

In some embodiments, the method 100 further comprises:
Step S180: in response to a predetermined virtual background delete operation, deleting the virtual background corresponding to the second video call mode from the first set of candidate virtual backgrounds; wherein, the virtual background corresponding to the first video call mode in the first set of candidate virtual backgrounds does not support being deleted.

In some embodiments, the method 100 further comprises:
Step S180: recording virtual backgrounds selected by the user for the first video call mode and the second video call mode respectively; wherein, the recorded virtual background selected by the user for the first video call mode is to be displayed when the first video call mode is started next time; the recorded virtual background selected by the user for the second video call mode is to be displayed when the second video call mode is started next time.

In this embodiment, by separately recording the virtual background selected by the user for the first video call mode and the second video call mode, the configuration of the virtual background by the user in different modes may be independent of each other. For example, the virtual background configured by the user in the first video call mode does not affect the configuration of the virtual background in the second video call mode.

Hereinafter, example illustration is presented below where the first video call mode is an interview call mode and the second video call mode is a conference call mode.

The permission used to set a default virtual background corresponding to the interview call mode may be a UAC permission (User Account Control), which requires the user to provide permissions or an administrator password before performing operations that might affect the running of the computer or that change settings of other users. This UAC permission may be granted only to administrators but not to other users. Therefore, only administrators can set the virtual background corresponding to the interview call mode in the background. According to the permission, administrators can set or modify exclusive virtual backgrounds for interviews by uploading pictures locally, entering URLs of pictures, selecting pictures from the pictures displayed by the system, etc. If the interviewer logs into the client for the first time and starts the first video call mode after the administrator has set or modified a virtual background, the interview-exclusive virtual background will be displayed by default in the local image display box. The above settings of the administrator do not affect the virtual background of the conference call mode.

The interviewer may select a virtual background from the first set of candidate virtual backgrounds after starting the interview call mode. The first set of candidate virtual backgrounds may display interview-exclusive virtual backgrounds configured by the administrator, virtual backgrounds used the conference mode, and virtual backgrounds uploaded by the user themselves. The interview-exclusive virtual background configured by the administrator may be pinned behind the predetermined background filter mark. The interviewer may further select and switch virtual backgrounds during the call with the interviewee by using the above method.

In the first set of candidate virtual backgrounds, the interview-exclusive virtual backgrounds configured by the administrator do not support being deleted. The user may add customized virtual backgrounds through the predetermined adding mark, and newly added customized virtual backgrounds are arranged by default after the interview-exclusive virtual backgrounds. The customized virtual background added by the user in the interview call mode may be displayed simultaneously in the conference call mode, e.g., may be displayed simultaneously in the set of candidate virtual backgrounds in the conference mode. However, the interview-exclusive virtual backgrounds configured by the administrator are not displayed in the conference call mode and in its set of candidate virtual backgrounds.

If the administrator resets a new interview-exclusive virtual background, when the interviewer logs in to the client for the first time and starts the interview call mode, the interview-exclusive virtual background reset by the administrator will be displayed in the local image display box.

The server may further be configured with a predetermined setting item to control whether users are allowed to use non-interview exclusive virtual backgrounds in the interview call mode, such as user-customized virtual backgrounds or virtual backgrounds corresponding to the conference call mode. The setting item may be controlled by the administrator.

Accordingly, as shown in FIG. 5, a video call apparatus 600 is provided according to one embodiment of the present disclosure, comprising:
a first mode starting unit 620 configured for, in response to a first video call mode of a client being selected, start the first video call mode;
a display unit 640 configured for display a video and a virtual background corresponding to the first video call mode in a local image display box; wherein the client further has a second video call mode, and a virtual background display policy corresponding to the first video call mode is different from a virtual background display policy corresponding to the second video call mode.

According to one or more embodiments of the present disclosure, the first video call mode is started in response to a first video call mode of a client being selected, and a video and a virtual background corresponding to the first video call mode are displayed in a local image display box; wherein the client further has a second video call mode, and a virtual background display policy corresponding to the first video call mode is different from a virtual background display policy corresponding to the second video call mode. In this way, a virtual background that matches the current video call mode can be displayed during a video call, thereby improving the adaptability of the virtual background to the current video call mode and meeting the user's diverse and personalized video call needs.

In some embodiments, the display unit is configured to, if the first video call mode is set with a first virtual background by the user with the predetermined permission, display the local first virtual background and the video in the image display box when the first video call mode is started for the first time after the first virtual background is set.

In some embodiments, the video call apparatus further comprises:
a first candidate virtual backgrounds set unit configured to, in response to a predetermined operation, display a first set of candidate virtual backgrounds corresponding to the first video call mode for the user to select a virtual background for the first video call mode; wherein the first set of candidate virtual backgrounds comprises a virtual background corresponding to the first video call mode and a virtual background corresponding to the second video call mode.

According to one or more embodiments of the present disclosure, the second video call mode corresponds to a second set of candidate virtual backgrounds, and the second set of candidate virtual backgrounds does not display the virtual background corresponding to the first video call mode.

In some embodiments, the video call apparatus further comprises:
a virtual background adding unit configured to, in response to the user adding a customized virtual background to the first set of candidate backgrounds, add the customized virtual background to the second set of candidate virtual backgrounds.

In some embodiments, the video call apparatus further comprises:
a virtual background deleting unit configured to, in response to a predetermined virtual background delete operation, delete the virtual background corresponding to the second video call mode from the first set of candidate virtual backgrounds; wherein the virtual background corresponding to the first video call mode in the first set of candidate virtual backgrounds does not support being deleted.

In some embodiments, the video call apparatus further comprises:
a recording unit configured to, record virtual backgrounds selected by the user for the first video call mode and the second video call mode, respectively; wherein the recorded virtual background selected by the user for the first video call mode is to be displayed when the first video call mode is started next time; the recorded virtual background selected by the user for the second video call mode is to be displayed when the second video call mode is started next time.

For the device's embodiments, since they basically correspond to the method embodiments, please refer to the description of the method embodiments for relevant information. The device embodiments described above are merely illustrative, and the modules described as separate modules may or may not be separate. Some or all of the modules may be selected according to actual needs to achieve the purpose of the embodiment solution. Those skilled in the art may understand and implement the method without any creative effort.

Accordingly, an electronic device is provided according to one or more embodiments of the present disclosure, comprising:
at least one memory and at least one processor;
wherein the memory is used to store program code, and the processor is used to call the program code stored in the memory to cause the electronic device to perform a video call method that are provided according to one or more embodiments.

Accordingly, a non-transitory computer storage medium is provided according to one or more embodiments of the present disclosure, the non-transitory computer storage medium stores program code thereon, which, when executed by a computer device, causes the computer device performs a video call method that are provided according to one or more embodiments.

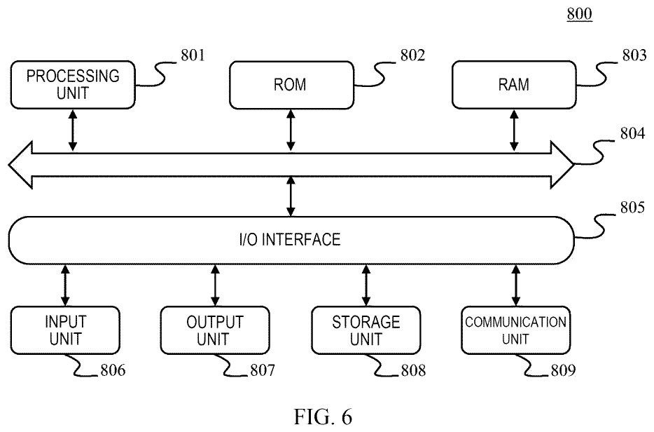

Refer to FIG. 6 below, which shows a schematic structural diagram of an electronic device (such as a terminal device or server) 800 suitable for implementing embodiments of the present disclosure. Terminal devices in embodiments of the present disclosure may include, but are not limited to, mobile phones, notebook computers, digital broadcast receivers, PDAs (personal digital assistants), PADs (tablet computers), PMP (portable multimedia players), vehicle-mounted terminals (such as vehicle-mounted Mobile terminals such as navigation terminals) and fixed terminals such as digital TVs, desktop computers, etc. The electronic device shown in FIG. 6 is only an example and should not impose any limitations on the functions and scope of use of the embodiments of the present disclosure.

As shown in FIG. 6, the electronic device 800 may include a processing unit (e.g., central processing unit, graphics processor, etc.) 801, which may be configured, according to a program stored in a read-only memory (ROM) 802 or from the storage unit 808, to load the program in the random access memory (RAM) 803 to perform various appropriate actions and processes. In the RAM 803, various programs and data required for the operation of the electronic device 800 are also stored. The processing unit 801, ROM 802 and RAM 803 are connected to each other via a bus 804. An input/output (I/O) interface 805 is also connected to bus 804.

Generally, the following devices may be connected to the I/O interface 805: input unit 806 including, for example, a touch screen, touch pad, keyboard, mouse, camera, microphone, accelerometer, gyroscope, etc.; and an output unit 807 including, for example, a liquid crystal display (LCD), speakers, vibration; a storage unit 808 including a magnetic tape, a hard disk, etc.; and a communication unit 809. The communication unit 809 may allow the electronic device 800 to communicate wirelessly or in the wired way with other devices to exchange data. Although FIG. 6 illustrates electronic device 800 with various means, it should be understood that implementation or availability of all illustrated means is not required. More or fewer means may alternatively be implemented or provided.

In particular, according to embodiments of the present disclosure, the processes described above with reference to the flowcharts may be implemented as computer software programs. For example, embodiments of the present disclosure include a computer program product including a computer program carried on a computer-readable medium, the computer program containing program code for executing the method shown in the flowchart. In such embodiments, the computer program may be downloaded and installed from the network via the communication unit 809, or from the storage unit 808, or from the ROM 802. When the computer program is executed by the processing unit 801, the above-mentioned functions defined in the method of embodiments of the present disclosure are performed.

It should be noted that the computer-readable medium mentioned above in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of computer readable storage media may include, but are not limited to: an electrical connection having one or more wires, a portable computer disk, a hard drive, random access memory (RAM), read only memory (ROM), removable memory Programmable read-only memory (EPROM or flash memory), optical fiber, portable compact disk read-only memory (CD-ROM), optical storage device, magnetic storage device, or any suitable combination of the above. In this disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program code therein. Such propagated data signals may take many forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or device. Program code embodied on a computer-readable medium may be transmitted using any suitable medium, including but not limited to: wire, optical fiber cable, RF (radio frequency), etc., or any suitable combination of the foregoing.

In some embodiments, the client and server can communicate using any currently known or future developed network protocol such as HTTP (HyperText Transfer Protocol), and can communicate with digital data in any form or medium. Communications (e.g., communications networks) interconnections. Examples of communication networks include local area networks (“LAN”), wide area networks (“WAN”), Internet networks (e.g., the Internet) and end-to-end networks (e.g., ad hoc end-to-end networks), as well as any currently known or future developed networks.

The above-mentioned computer-readable medium may be included in the above-mentioned electronic device; it may also exist independently without being assembled into the electronic device.

The above-mentioned computer-readable medium carries one or more programs. When the above-mentioned one or more programs are executed by the electronic device, the electronic device is caused to perform the above-mentioned method of the present disclosure.

Computer program code for performing the operations of the present disclosure may be written in one or more programming languages, including object-oriented programming languages such as Java, Smalltalk, C++, and conventional Procedural programming language, such as “C” language or similar programming language. The program code may execute entirely on the user's computer, partly on the user's computer, as a stand-alone software package, partly on the user's computer and partly on a remote computer or entirely on the remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the accompanying drawings illustrate the architecture, functionality, and operations of systems, methods, and computer program products that may be implemented in accordance with various embodiments of the present disclosure. In this regard, each block in the flowchart or block diagram may represent a module, segment, or portion of code that contains one or more logic functions that implement the specified executable instructions. It should also be noted that, in some alternative implementations, the functions noted in the block may occur out of the order noted in the figures. For example, two blocks shown one after another may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, can be implemented by special purpose hardware-based systems that perform the specified functions or operations, or can be implemented by a combination of specialized hardware and computer instructions.

The units involved in the embodiments described in this disclosure can be implemented in software or hardware. Among them, the name of a unit does not constitute a limitation on the unit itself under certain circumstances.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, devices or devices, or any suitable combination of the foregoing. More specific examples of machine-readable storage media would include one or more wires based electrical connection, laptop disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, a video call method is provided, comprising: in response to a first video call mode of a client being selected, starting the first video call mode; displaying a video and a virtual background corresponding to the first video call mode in a local image display box; wherein the client further has a second video call mode, and a virtual background display policy corresponding to the first video call mode is different from a virtual background display policy corresponding to the second video call mode.

According to one or more embodiments of the present disclosure, the virtual background corresponding to the first video call mode is a virtual background that is set for the first video call mode by a user with a predetermined permission.

According to one or more embodiments of the present disclosure, displaying the video and the virtual background corresponding to the first video call mode in the local image display box comprises: if the first video call mode is set with a first virtual background by the user with the predetermined permission, displaying the local first virtual background and the video in the image display box when the first video call mode is started for the first time after the first virtual background is set.

According to one or more embodiments of the present disclosure, the method further comprises: in response to a predetermined operation, displaying a first set of candidate virtual backgrounds corresponding to the first video call mode for the user to select a virtual background for the first video call mode; wherein the first set of candidate virtual backgrounds comprises a virtual background corresponding to the first video call mode and a virtual background corresponding to the second video call mode.

According to one or more embodiments of the present disclosure, in the first set of candidate virtual backgrounds, the virtual background corresponding to the first video call mode has a higher display priority than the virtual background corresponding to the second video call mode.

According to one or more embodiments of the present disclosure, in the first set of candidate virtual backgrounds, the virtual background corresponding to the first video call mode having a higher display priority than the virtual background corresponding to the second video call mode comprises: in the first set of candidate virtual backgrounds, marking the virtual background corresponding to the first video call mode by a predetermined mark corresponding to the first video call mode; and/or in the first set of candidate virtual backgrounds, the virtual background corresponding to the first video call mode is before the virtual background corresponding to the second video call mode.

According to one or more embodiments of the present disclosure, the second video call mode corresponds to a second set of candidate virtual backgrounds, and the second set of candidate virtual backgrounds does not display the virtual background corresponding to the first video call mode.

According to one or more embodiments of the present disclosure, the method further comprises: in response to the user adding a customized virtual background to the first set of candidate backgrounds, adding the customized virtual background to the second set of candidate virtual backgrounds.

According to one or more embodiments of the present disclosure, the method further comprises: in response to a predetermined virtual background delete operation, deleting the virtual background corresponding to the second video call mode from the first set of candidate virtual backgrounds; wherein the virtual background corresponding to the first video call mode in the first set of candidate virtual backgrounds does not support being deleted.

According to one or more embodiments of the present disclosure, the method further comprises: recording virtual backgrounds selected by the user for the first video call mode and the second video call mode, respectively; wherein the recorded virtual background selected by the user for the first video call mode is to be displayed when the first video call mode is started next time; the recorded virtual background selected by the user for the second video call mode is to be displayed when the second video call mode is started next time.

According to one or more embodiments of the present disclosure, the first video call mode comprises an interview call mode.

According to one or more embodiments of the present disclosure, the second video call mode comprises a conference call mode.

According to one or more embodiments of the present disclosure, there is provided a video call apparatus, comprising: a first mode starting unit configured for, in response to a first video call mode of a client being selected, start the first video call mode; a display unit configured for display a video and a virtual background corresponding to the first video call mode in a local image display box; wherein the client further has a second video call mode, and a virtual background display policy corresponding to the first video call mode is different from a virtual background display policy corresponding to the second video call mode.

According to one or more embodiments of the present disclosure, there is provided an electronic device, comprising: at least one memory and at least one processor; wherein the memory is used to store program code, and the processor is used to call the program code stored in the memory to cause the electronic device to perform a video call method according to one or more embodiments of the present disclosure.

According to one or more embodiments of the present disclosure, there is provided a non-transitory computer storage medium, the non-transitory computer storage medium stores program code thereon, which, when executed by a computer device, causes the computer device performs a video call method according to one or more embodiments of the present disclosure.

The above description is only a description of the preferred embodiments of the present disclosure and the technical principles used. Those skilled in the art should understand that the disclosure scope involved in the present disclosure is not limited to technical solutions composed of specific combinations of the above technical features, but should also cover solutions including the above technical features or without departing from the above disclosed concept. Other technical solutions formed by any combination of equivalent features. For example, a technical solution is formed by replacing the above features with technical features with similar functions disclosed in this disclosure (but not limited to).

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features described in the context of individual embodiments may also be implemented in combination in a single embodiment. Conversely, various features that are described in the context of a single embodiment can also be implemented in multiple embodiments individually or in any suitable sub-combination.

Although the present subject matter has been described in language specific to structural features and/or methodological logical acts, it should be understood that the subject matter defined in the accompanying claims is not necessarily limited to the specific features or acts described above. Rather, the specific features and actions described above are merely example forms of implementing claims.

1. A video call method, comprising:
in response to a first video call mode of a client being selected, starting the first video call mode;
displaying a video and a virtual background corresponding to the first video call mode in a local image display box;
wherein the client further has a second video call mode, and a virtual background display policy corresponding to the first video call mode is different from a virtual background display policy corresponding to the second video call mode.

2. The video call method of claim 1, wherein the virtual background corresponding to the first video call mode is a virtual background that is set for the first video call mode by a user with a predetermined permission.

3. The video call method of claim 2, wherein displaying the video and the virtual background corresponding to the first video call mode in the local image display box comprises:
in response to a determination that the first video call mode is set with a first virtual background by the user with the predetermined permission, displaying the local first virtual background and the video in the image display box in response to a determination that the first video call mode is started for the first time after the first virtual background is set.

4. The video call method of claim 1, further comprising:
in response to a predetermined operation, displaying a first set of candidate virtual backgrounds corresponding to the first video call mode for the user to select a virtual background for the first video call mode;
wherein the first set of candidate virtual backgrounds comprises a virtual background corresponding to the first video call mode and a virtual background corresponding to the second video call mode.

5. The video call method of claim 4, wherein in the first set of candidate virtual backgrounds, the virtual background corresponding to the first video call mode has a higher display priority than the virtual background corresponding to the second video call mode.

6. The video call method of claim 5, wherein in the first set of candidate virtual backgrounds, the virtual background corresponding to the first video call mode having a higher display priority than the virtual background corresponding to the second video call mode comprises
in the first set of candidate virtual backgrounds, marking the virtual background corresponding to the first video call mode by a predetermined mark corresponding to the first video call mode; and/or
in the first set of candidate virtual backgrounds, displaying the virtual background corresponding to the first video call mode before the virtual background corresponding to the second video call mode.

7. The video call method of claim 4, wherein the second video call mode corresponds to a second set of candidate virtual backgrounds, and the second set of candidate virtual backgrounds does not display the virtual background corresponding to the first video call mode.

8. The video call method of claim 7, further comprising:
in response to the user adding a customized virtual background to the first set of candidate backgrounds, adding the customized virtual background to the second set of candidate virtual backgrounds.

9. The video calling method of claim 4, further comprising:
in response to a predetermined virtual background delete operation, deleting the virtual background corresponding to the second video call mode from the first set of candidate virtual backgrounds;
wherein the virtual background corresponding to the first video call mode in the first set of candidate virtual backgrounds does not support being deleted.

10. The video call method of claim 1, further comprising:
recording virtual backgrounds selected by the user for the first video call mode and the second video call mode, respectively;
wherein the recorded virtual background selected by the user for the first video call mode is to be displayed in response to a determination that the first video call mode is started next time; the recorded virtual background selected by the user for the second video call mode is to be displayed in response to a determination that the second video call mode is started next time.

11. The video call method of claim 1, wherein the first video call mode comprises an interview call mode.

12. The video call method of claim 11, wherein the second video call mode comprises a conference call mode.

13. (canceled)

14. An electronic device, comprising:
at least one memory and at least one processor;
wherein the memory is used to store program code, and the processor is used to call the program code stored in the memory to cause the electronic device to perform a method, the method comprising:
in response to a first video call mode of a client being selected, starting the first video call mode;
displaying a video and a virtual background corresponding to the first video call mode in a local image display box;
wherein the client further has a second video call mode, and a virtual background display policy corresponding to the first video call mode is different from a virtual background display policy corresponding to the second video call mode.

15. A non-transitory computer storage medium, wherein the non-transitory computer storage medium stores program code thereon, which, when executed by a computer device, causes the computer device performs a method, the method comprising:
in response to a first video call mode of a client being selected, starting the first video call mode;
displaying a video and a virtual background corresponding to the first video call mode in a local image display box;
wherein the client further has a second video call mode, and a virtual background display policy corresponding to the first video call mode is different from a virtual background display policy corresponding to the second video call mode.

16. The electronic device of claim 14, wherein the virtual background corresponding to the first video call mode is a virtual background that is set for the first video call mode by a user with a predetermined permission.

17. The electronic device of claim 16, wherein displaying the video and the virtual background corresponding to the first video call mode in the local image display box comprises:
in response to a determination that the first video call mode is set with a first virtual background by the user with the predetermined permission, displaying the local first virtual background and the video in the image display box in response to a determination that the first video call mode is started for the first time after the first virtual background is set.

18. The electronic device of claim 14, wherein the method further comprises:
in response to a predetermined operation, displaying a first set of candidate virtual backgrounds corresponding to the first video call mode for the user to select a virtual background for the first video call mode;
wherein the first set of candidate virtual backgrounds comprises a virtual background corresponding to the first video call mode and a virtual background corresponding to the second video call mode.

19. The electronic device of claim 18, wherein in the first set of candidate virtual backgrounds, the virtual background corresponding to the first video call mode has a higher display priority than the virtual background corresponding to the second video call mode.

20. The electronic device of claim 19, wherein in the first set of candidate virtual backgrounds, the virtual background corresponding to the first video call mode having a higher display priority than the virtual background corresponding to the second video call mode comprises
in the first set of candidate virtual backgrounds, marking the virtual background corresponding to the first video call mode by a predetermined mark corresponding to the first video call mode; and/or
in the first set of candidate virtual backgrounds, displaying the virtual background corresponding to the first video call mode before the virtual background corresponding to the second video call mode.

21. The electronic device of claim 18, wherein the second video call mode corresponds to a second set of candidate virtual backgrounds, and the second set of candidate virtual backgrounds does not display the virtual background corresponding to the first video call mode.
